(19) United States
(12) Patent Application Publication
(10) Pub. No.: US 2010/0232334 A1
(43) Pub. Date: Sep. 16, 2010

(54) BASE STATION AND METHOD OF AVOIDING FLOOD OF JOIN MESSAGES FOR IP MULTICAST GROUP IN PORTABLE INTERNET NETWORK

(75) Inventors: Myung-Ki Shin, Daejeon-city (KR); Sangjin Jeong, Daejeon-city (KR); Joo-Chul Lee, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTIT, Daejeon-city (KR)

(21) Appl. No.: 12/280,302

(22) PCT Filed: Feb. 21, 2007
(86) PCT No.: PCT/KR2007/000900

§ 371 Date: Aug. 21, 2008

(30) Foreign Application Priority Data
Feb. 23, 2006 (KR) 10-2006-0017891
Nov. 16, 2006 (KR) 10-2006-0113476

(51) Int. Cl. H04H 20/71

(52) U.S. Cl. 370/312

(57) ABSTRACT

Provided is a base station (BS) and method of avoiding a flood of join messages for an Internet protocol (IP) multicast group in a portable Internet network, and more particularly, to a BS and method of transmitting join messages for an Internet IP multicast group to an access router or other BSs with a predetermined delay time in an IP multicast (IP version 4 (IPv4) or IP version 6 (IPv6)) service in an IEEE 802.16/Wireless Broadband (WiBro) network. In addition, the BS immediately transmits the join message for the group to other user terminals which belong to the BS. Accordingly, a problem whereby a method of avoiding a flood of multicast group join messages cannot be applied due to point-to-multipoint characteristics of the portable Internet network such as the IEEE 802.16/WiBro network is solved. In addition, the method of avoiding a flood of join messages can be applied using both IPv4 multicast and IPv6 multicast services.

### CROSS-REFERENCE TO RELATED PATENT APPLICATION

This application claims the benefits of Korean Patent Application No. 10-2006-0017891, filed on Feb. 23, 2006, and Korean Patent Application No. 10-2006-0113476, filed on Nov. 16, 2006, in the Korean Intellectual Property Office, the disclosures of which are incorporated herein in their entirety by reference.

### BACKGROUND OF THE INVENTION

1. Field of the invention

The present invention relates to a method and apparatus for avoiding a flood of join messages for a multicast group, and more particularly, to a base station (BS) and a method of transmitting join messages for an Internet protocol (IP) multicast group to an access router or other BSs with a predetermined delay time in an IP multicast (an IP version 4 (IPv4) or IP version 6 (IPv6)) service in an IEEE 802.16/Wireless Broadband (WiBro) network.

2. Description of the Related Art

In general, Internet group management protocol (IGMP) messages may include a host membership report message, a host membership query message, and a leave group message.

The host membership report message is sent when a host joins a multicast group so as to declare membership in a specific host group. The host membership query message is used by a multicast router to periodically poll a network for group members. The leave group message is sent by a host when it leaves a host group and is the last member of that group on the network segment.

Similar to the host membership report message, a join message for a multicast group in a portable Internet network is transmitted by user terminal which wants to join a specific multicast group over the network.

In an IP multicast method in related conventional art, each user terminal transmits a join message to an access router. In addition, in this method, it is required to avoid a flood of join messages for a multicast group. The core of this method is that, each user terminal does not immediately transmit a join message for the multicast group in order to join a multicast group, but waits for a time from 0 to a maximum response time (the maximum response time is generally set to 1/10 second) by using a delay timer. Therefore, when many user terminals transmit join messages for a multicast group in a single sub network, the messages are prevented from flooding the sub network. This method uses characteristics of a broadcast network such as an Ethernet network, so that the method is limited to a broadcast system in which a message transmitted by a single user terminal can be transmitted to all user terminals in a sub network.

However, recently, an IEEE 802.16 based transmitting method having new wireless network characteristics such as WiBro does not provide a method that is performed in a broadcast manner, but uses a message transmitting method that is performed in a point-to-multipoint manner. Therefore, in this case, there is a problem in that the existing method of avoiding a flood of multicast group join messages provided in an IP multicast method in the related conventional art cannot be used.

### SUMMARY OF THE INVENTION

The present invention provides a method and apparatus for avoiding a flood of multicast group join messages, and more particularly, a base station (BS) and method capable of preventing an excessive distribution of multicast group join messages by reflecting a delay time of a delay timer in a portable Internet network having point-to-multipoint characteristics.

According to an aspect of the present invention, there is provided a BS for avoiding a flood of join messages for an IP (Internet protocol) multicast group in a portable Internet network, the BS including: a receiver receiving the join message for the IP multicast group from a first user terminal which wants to join the IP multicast group; and a transmitter transmitting the received join message for the group to other user terminals which belong to the BS and when the join message for the group is not received from a second user terminal during a set time after the receiver receives the join message for the group from the first user terminal, transmitting the received join message for the group to an access router to which the BS belongs and other BSs which belong to the access router.

According to another aspect of the present invention, there is provided a method of processing a join message by a BS (base station) for avoiding a flood of join messages for an IP multicast group in a portable Internet network, the method including: receiving the join message for the IP multicast group from a first user terminal which wants to join the IP multicast group; transmitting the received join message for the group to other user terminals which belong to the BS; and when the join message for the group is not received from a second user terminal during the set time after the join message for the group is received from the first user terminal, transmitting the received join message for the group to an access router to which the BS belongs and other BSs which belong to the access router.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a structure of a general IEEE 802.16/Wireless Broadband (WiBro) network;

FIG. 2 is a view showing base stations (BSs) for avoiding a flood of multicast group join messages in a portable Internet network such as an IEEE 802.16/WiBro network according to an embodiment of the present invention;

FIG. 3 is a view showing operations of transmitting multicast group join messages between user terminals and BSs according to an embodiment of the present invention;

FIG. 4 is a view showing operations of transmitting multicast group join messages between user terminals and the BSs after the transmitting operations illustrated in FIG. 3 have been performed, according to an embodiment of the present invention; and

FIG. 5 is a flowchart showing processing operations for avoiding a flood of multicast group join messages by a BS in a portable Internet network according to an embodiment of the present invention.

### DETAILED DESCRIPTION OF THE INVENTION

Hereinafter, exemplary embodiments of the present invention will be described in detail with reference to the attached drawings.

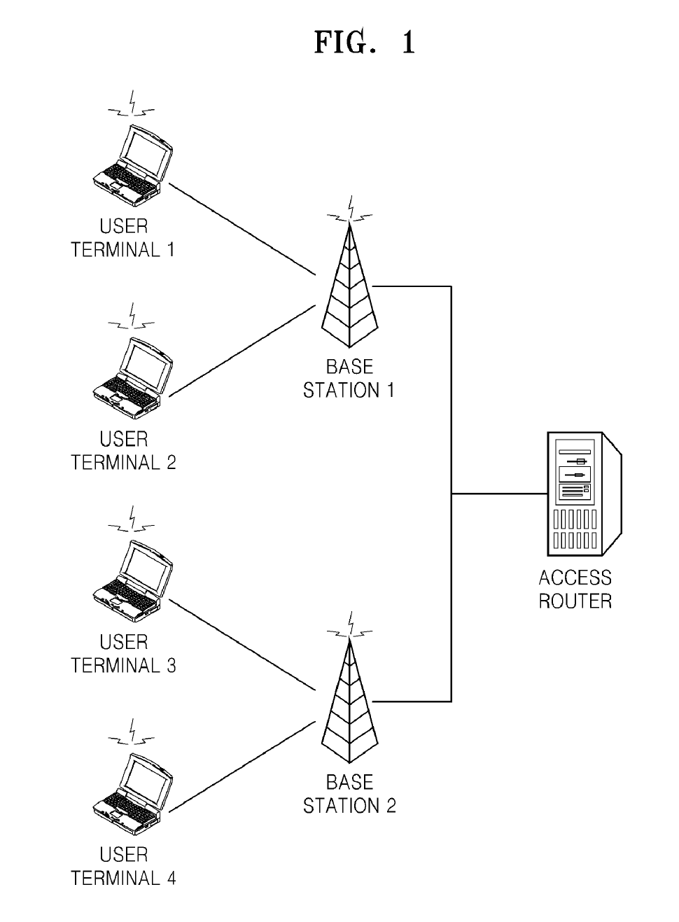

FIG. 1 is a view showing a structure of a general IEEE 802.16/Wireless Broadband (WiBro) network.

Referring to FIG. 1, in the IEEE 802.16/Wibro network, an access router is connected to two or more base stations (BSs), and each BS is wirelessly connected to multiple user terminals in point-to-multipoint manner.

According to an embodiment of the present invention, when an Internet protocol (IP) multicast (IP version 4 (IPv4) or IP version 6 (IPv6)) service is provided in the IEEE 802.16/WiBro network, a user terminal may transmit a multicast group join message to a BS. In this case, the BS which receives the multicast group join message transmits it to other user terminals which belong to the BS, and the BS transmits the multicast group join message to an access router to which the BS belongs and to other BSs.

More specifically, when the BS transmits the multicast group join message to the access router to which the BS belongs and to other BS, the BS may not immediately transmit the multicast group join message and delay transmitting for a time from 0 to a maximum response time by using a delay timer. In addition, when the BS receives the same multicast group join message from another BS during the delay time, the BS may not transmit the multicast group join message which is received in advance and destroy the multicast group message received in advance. In other words, only when the BS does not receive the same multicast group join message from another BS during the delay time, the BS then transmits the multicast group join message to the access router to which the BS belongs and to other BSs.

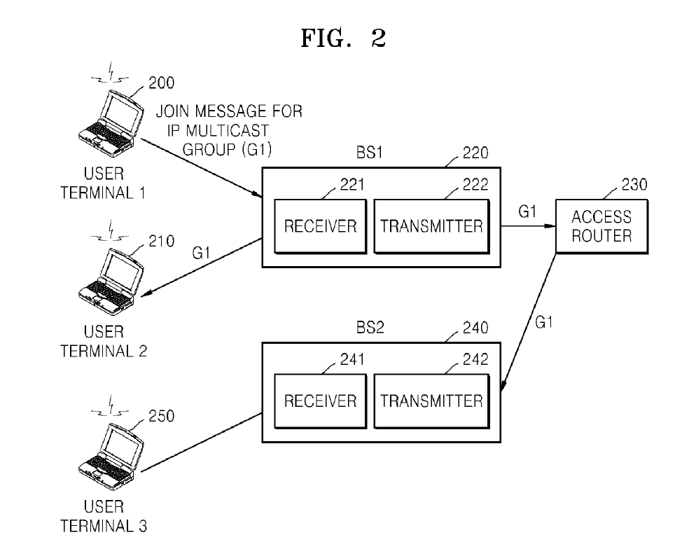

FIG. 2 is a view showing BSs for avoiding a flood of multicast group join messages in a portable Internet network such as an IEEE 802.16/Wibro network according to an embodiment of the present invention.

In the IEEE 802.16/WiBro network, user terminals are connected to BSs in a point-to-multipoint manner. Accordingly, there is a problem in that a conventional method of avoiding a flood of IP multicast group join messages cannot be used in this case. On the contrary, according to the embodiment of the present invention, multicast group join messages can be effectively transmitted in the IEEE 802.16/WiBro network, and more particularly, the multicast group join messages do not flood.

According to the current embodiment of the present invention, an additional function to solve the aforementioned problem is provided to a BS which is an essential member in the IEEE 802.16/WiBro network. More specifically, the BS transmits a multicast group join message received from a user terminal to other user terminals in the same sub network, but the BS does not immediately transmit the message and waits for a time from 0 to a maximum response time (the maximum response time is generally set to 1/10 second) by using a delay timer by applying the method of avoiding a flood of IP multicast group join messages. Therefore, the method of avoiding a flood of IP multicast group join messages in the related conventional art can be implemented in the IEEE 802.16/VViBro network, and an effective multicast service can be provided in the IEEE 802.16/WiBro network. The aforementioned method can be applied to both the IPv4 and the IPv6.

The BS 220 includes a receiver 221 for receiving a join message for an IP multicast group from a first user terminal and a transmitter 222 which transmits the received join message for the group to other user terminals that belong to the BS 220 and transmits the received join message for the group to an access router 230 to which the BS 220 belongs and to another BS 240 which belongs to the access router 230 when the receiver 221 does not receive a join message for the group from a second user terminal during a set time after receiving the join message for the group from the first user terminal. However, when the first user terminal belongs to another BS, the transmitter 222 does not transmit the received join message for the group to the access router 230 to which the BS 220 belongs and to the other BS 240 which belongs to the access router 230.

Referring to FIG. 2, when a user terminal 200 which wants to receive a multicast service transmits a join message G1 for a corresponding multicast group, a BS 220 which receives the join message transmits the message to other user terminals 210, and at the same time, the BS 220 does not immediately transmit the same message to another BS 240 which belongs to an access router to which the BS 220 belongs and delays transmitting for a time from 0 to a maximum response time (the maximum response time is generally set to 1/10 second) by using a delay timer by applying the method of avoiding a flood of multicast group join message.

Next, when the BS 220 does not receive a join message for the corresponding multicast group from other user terminals after the delay timer is terminated, the BS 220 transmits the join message to the access router to which the BS 220 belongs and to the other BS 240 which belongs to the access router (operation 2). When another user terminal 210 connected to the BS 220 wants to transmit a join message for the same multicast group, since another user terminal 210 already received the join message for the multicast group from the BS 220, another user terminal 210 may not transmit the message.

At the same time, when a user terminal 250, which is connected to another

BS 240 which belongs to the same access router 230, transmits a join message for the same multicast group, since the BS 240 received the join message for the corresponding multicast group in advance from the BS 220, the BS 240 does not transmit the message received from the user terminal 250 to the access router 230 to which the BS 240 belongs or to the BS 220 which belongs to the access router 230. By means of the aforementioned operations, a problem, whereby the method of avoiding a flood of multicast group join messages in a portable Internet network such as the IEEE 802.16/Wibro network in the related conventional art cannot be used, is solved, and the method of avoiding a flood of multicast group join messages can also be used in the portable Internet network.

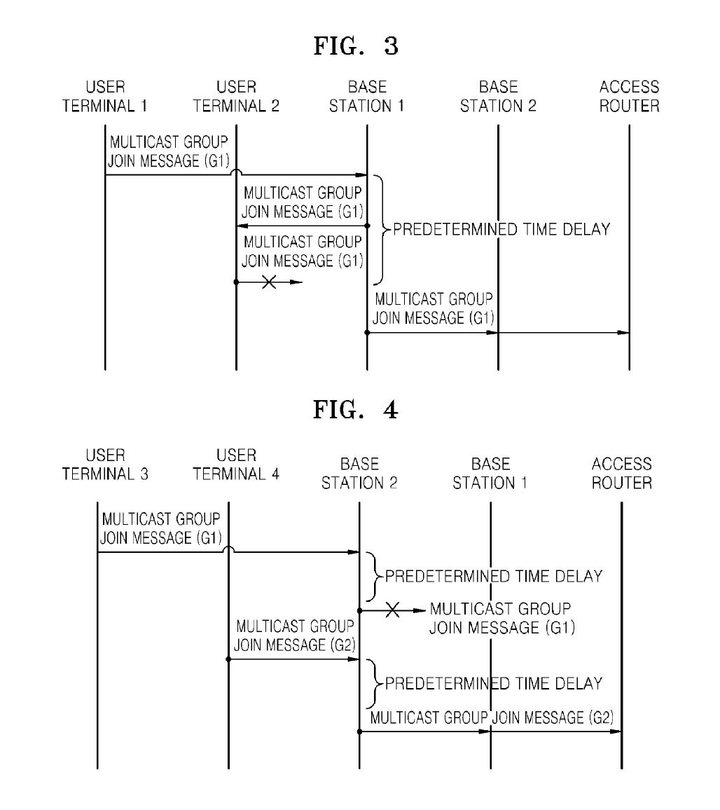

FIG. 3 is a view showing operations of transmitting multicast group join messages between user terminal and BSs according to an embodiment of the present invention.

Transmitting operations will be described with reference to FIG. 3.

When a user terminal 1 transmits a join message 01 for the multicast group in order to join a multicast group, a BS 1 receives the message and transmits the join message G1 for the multicast group to a user terminal 2 which belongs to the BS 1. On the other hand, the BS 1 does not immediately transmit the join message G1 to an access router and a BS 2 but instead delays transmitting for a time from 0 to a maximum response time (the maximum response time is generally set to 1/10 second) by using a delay timer and applying the method of avoiding a flood of multicast group join messages. The BS 1 transmits the join message G1 to the access router and the BS 2 only when the BS 1 does not receive a join message G1 for the multicast group during the delay time.

If the user terminal 2 wants to join the multicast group, since the user terminal 2 already received the join message G1 for the multicast group transmitted by the user terminal 1 from the BS 1, the user terminal 2 does not need to additionally transmit a join message to the BS 1.

FIG. 4 is a view showing operations of transmitting multicast group join messages between user terminals and the BSs after the transmitting operations illustrated in FIG. 3 have been performed, according to an embodiment of the present invention.

Transmitting operations will be described with reference to FIG. 4.

After the operations described with reference to FIG. 3 have been performed, a user terminal 3 which belongs to the BS 2 may transmit a join message for the multicast group in order to join a multicast group. In this case, the BS 2 receives the message but does not immediately transmit the message to the access router and the BS 1 and has to delay transmitting for a time from 0 to a maximum response time (the maximum response time is generally set to 1/10 second) by using a delay timer and applying the method of avoiding a flood of multicast messages. However, in this case, since the BS 2 already received the join message for the multicast group in operations shown in FIG. 3, the BS 2 does not to transmit the message G1 to the access router or the BS 1.

However, when the BS 2 receives a new join message G2 for another multicast group in order to join another multicast group, operations described with reference to FIG. 3 are performed.

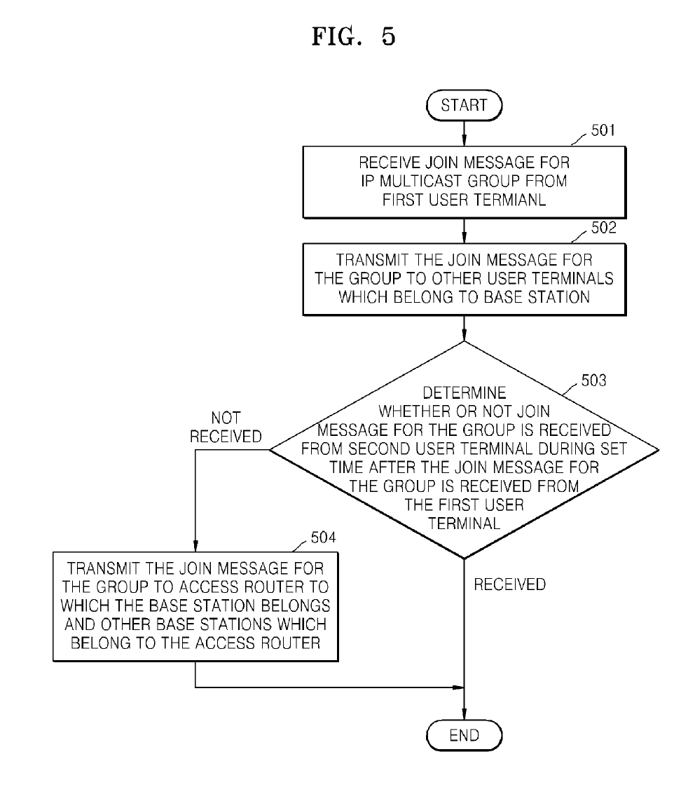

FIG. 5 is a flowchart showing processing operations for avoiding a flood of multicast group join messages by a BS in a portable Internet network according to an embodiment of the present invention.

A BS receives a join message for the IP multicast group from a first user terminal which wants to join an IP multicast group (operation 501), and the BS transmits the received join message for the group to other user terminals which belong to the BS (operation 502).

Next, the BS identifies whether or not a join message for the group is received from a second user terminal during a set time after receiving the join message for the group from the first user terminal (operation 503). When the BS does not receive the join message for the group from the second user terminal, the BS transmits the received join message for the group to an access router to which the BS belongs and other BSs which belong to the access router (operation 504).

The first user terminal may belong to the BS, and the second user terminal may belong to another BS. However, when the first user terminal belongs to another BS, the BS does not need not transmit the received join message for the group to the access router to which the BS belongs and other BS which belong to the access router.

Accordingly, the problem whereby the conventional method of avoiding a flood of multicast group join messages cannot be applied due to point-to-multipoint characteristics of the portable Internet network such as the IEEE 802.16/Wibro network is solved. In addition, a new function for processing the multicast group join messages is defined and added to a BS which is a member of the IEEE 802.16/Wibro network. Therefore, there is an advantage in that the method of avoiding a flood of multicast group join messages can be applied when an IP multicast service is provided in the IEEE 802.16/Wibro network. The method can be applied using both IPv4 multicast and IPv6 multicast services.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the present invention as defined by the appended claims.

1. A BS (base station) for avoiding a flood of join messages for an IP (Internet protocol) multicast group in a portable Internet network, the BS comprising:
a receiver receiving the join message for the IP multicast group from a first user terminal which wants to join the IP multicast group; and
a transmitter transmitting the received join message for the group to other user terminal which belong to the BS and, when the join message for the group is not received from a second user terminal during a set time after the receiver receives the join message for the group from the first user terminal, transmitting the received join message for the group to an access router to which the BS belongs and other BSs which belong to the access router.

2. The BS of claim 1,
wherein the first user terminal belongs to the BS, and
wherein the second user terminal belongs to another BS.

3. The BS of claim 1, wherein, when the first user terminal belongs to another BS, the transmitter does not transmit the received join message for the group to the access router to which the BS belongs and the other BSs which belong to the access router.

4. The BS of claim 1, wherein, when the transmitter does not receive the join message for the group from the second user terminal during the set time while delays transmitting for the set time by using a delay timer, the transmitter transmits the received join message for the group to the access router to which the BS belongs and the other BSs which belong to the access router.

5. The BS of claim 1,
wherein the portable Internet network is an IEEE 802.16 network, and
wherein the IP multicast group is an IPv4 (IP version 4) multicast group or an IPv6 (IP version 6) multicast group.

6. A method of processing a join message by a BS (base station) for avoiding a flood of join messages for an IP multicast group in a portable Internet network, the method comprising:
receiving the join message for the IP multicast group from a first user terminal which wants to join the IP multicast group;
transmitting the received join message for the group to other user terminals which belong to the BS; and
when the join message for the group is not received from a second user terminal during the set time after the join message for the group is received from the first user terminal, transmitting the received join message for the group to an access router to which the BS belongs and other BSs which belong to the access router.

7. The method of claim 6,
wherein the first user terminal belongs to the BS, and
wherein the second user terminal belongs to another BS.

8. The method of claim 6, wherein, when the first user terminal belongs to another BS, the transmitting is not performed.

9. The method of claim 6, wherein, in the transmitting, the set time is a set time to be delayed by a delay timer in the BS.

10. The method of claim 6,
wherein the portable Internet network is an IEEE 802.16 network, and
wherein the IP multicast group is an IPv4 multicast group or an IPv6 multicast group.

11. A computer-readable medium having recorded thereon a computer program for executing the method of claim 6.

12. A computer-readable medium having recorded thereon a computer program for executing the method of claim 7.

13. A computer-readable medium having recorded thereon a computer program for executing the method of claim 8.

14. A computer-readable medium having recorded thereon a computer program for executing the method of claim 9.

15. A computer-readable medium having recorded thereon a computer program for executing the method of claim 10.
